(19) United States
(12) Patent Application Publication
(10) Pub. No.: US 2012/0000129 A1
(43) Pub. Date: Jan. 5, 2012

(54) Slide/swing door

(76) Inventor: Viacheslav Maratovich Kuznetsov, Sankt-Peterburg (RU)

(21) Appl. No.: 12/928,544

(22) Filed: Dec. 14, 2010

(30) Foreign Application Priority Data
Jul. 1, 2010 (RU) 2010127057

(51) Int. Cl. E05D 15/22; E05B 65/06; E05F 15/12

(52) U.S. Cl. 49/180; 49/177

(57) ABSTRACT

A slide/swing door has at least one horizontally-movable part, a mechanism for moving the part including guiding rails and elements of movement arranged on the guiding rails, a part suspended on the elements of movement, wherein the part is formed as a swing door including a door frame, a door panel, on hinges, and a fixator.

### BACKGROUND OF THE INVENTION

The present invention relates to constructions of doors for industrial and presidential buildings.

RU 2099,204 discloses a door for protection from intruding, shooting, breaking and access of unauthorized people, which has guides, sliding elements, an electric motor, a drive, and a device for controlling the electric motor with the functional blocking.

A slide/swing door and a holder of the door are disclosed in WO2006/120742. During opening and closing of the door, the door plate slides to the left and to the right and simultaneously is turned. The disadvantage of this door is its significant size in an open position, and also a complicated construction and assembly of the door.

A slide/swing door for a patio is disclosed in U.S. Pat. No. 6,422,287. It has a door plate composed of two panels. The first panel can slide on the guides on the second panel the door plate can be turned, as in a conventional swing door, when the first panel is placed on the second. The disadvantage of this function is that it is complicated and not reliable.

Also, a door or partition with an upper suspension is disclosed in utility model RU55838. It has one or more horizontally movable parts formed as an aluminum frame, a holding seal plate, and a mechanism of moving of parts connected to an upper edge, located above the parts and formed as guiding rails with moving roller carriages on them, on which the parts of the door and partitions are suspended. The disadvantage of this door is that it is not possible to use the door as a conventional swing door.

### SUMMARY OF THE INVENTION

Accordingly, it is an object of the present invention to provide a slide/swing door which avoids the disadvantages of the prior art.

More particularly, it is an object of the present invention to provide a slide/swing door which has expanded functions and is easy to use.

In keeping with these objects and with others which will become apparent hereinafter, one feature of the present invention resides, briefly stated, in a slide/swing door which has at least one horizontal-movable part and a mechanism of moving to the part, including guiding rails with moving elements arranged on them, on which the part is suspended, wherein the part is swing door including a door frame, a door plate on hinges and a fixator.

As a result the door can be opened as a sliding door and as a swing door, depending on when it is needed correspondingly.

The elements of movement can be formed for example as roller carriages.

In accordance with another embodiment, the door has an electric motor, a drive and a device for controlling the electric motor with a blocking function. The electric motor is used for movement of the part in a horizontal direction, instead of moving it manually. The device for blocking prevents displacement of the part in a condition when it is swung open.

In accordance with another embodiment, the slide/swing door additionally has a lower guide, to prevent shifting of the part.

In accordance with still another embodiment the door frame of the swing door is formed by two parts connected with another perpendicularly, to simplify the construction and to reduce the weight of the door. In accordance with a further embodiment, the swing door is provided with additional moving element.

In accordance with still a further embodiment, the swing door is provided with a closing element.

In another embodiment, the hinges of the swing door are formed as hidden hinges. This allow to reduce a gap between the door plate and the door frame.

The swing door in accordance with the present invention can be provided also with a lock. The slide/swing door in accordance with the present invention can be also provided with two additionally horizontally-movable parts.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a slide/swing door in accordance with the present invention;

FIG. 2 is a side view of the slide/swing door in accordance with the present invention;

FIG. 3 is a plan view of the slide/swing door in accordance with the present invention;

FIG. 4 is a view showing the slide/swing door with two parts.

### DESCRIPTION OF THE PREFERRED EMBODIMENTS

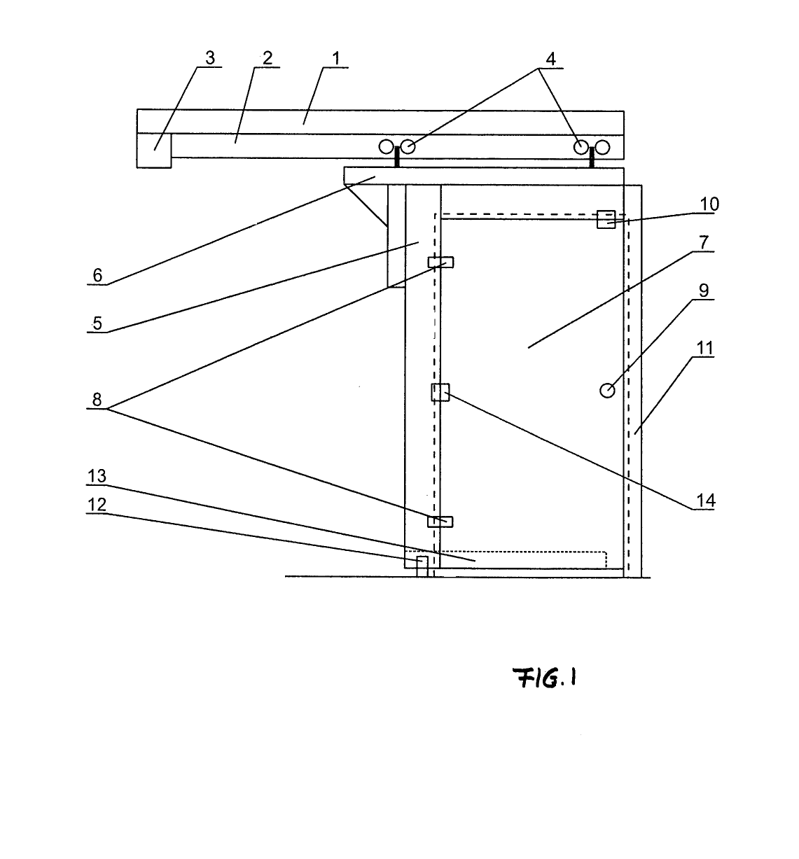

A slide/swing door in accordance with the present invention is shown in FIG. 1 and has a mounting bar 1, with an upper guide 2 connected to the bar and formed as a metal profile, and an electric motor 3. Rollers 4 are introduced in the upper guide. A horizontally-movable part which forms a swing door is suspended on the rollers 4. The rollers 4 make possible manual displacement of the part along the upper guide to the left and to the right.

** Mr Z check the word “hinges”, maybe it is “loops”.

The part is composed of door box 5 which is reinforced with a metal angle 6, a door plate 7, hidden hinges 8, a lock 9, and fixator 10. The fixator 10 fixes the door plate 7 in the door box 5 in a closed position.

A closing element 11 is mounted in the door space and provides a tight closing of the door, with corresponding part for the lock 9.

The lower guide is formed as a flat 12 which is engaged in slots 13. This construction prevents shifting of the part.

The electric motor 3 is connected by the drive with the rollers 4 and provides horizontal movement of the part when, in response to pressing of a not shown button, instead manual displacement.

A contact 14 arranged between the door plate 7 and the door box 5 prevents automatic movement of the part, when the swing door is not completely closed.

The swing door can additionally include a hidden element for completing the closure.

The whole structure can be provided with a second horizontally movable part as shown in FIG. 4, which moves in an opposite direction in a mirror in a similar manner. In this case the closing element is not needed, and the corresponding part for the lock is mounted in one of the doors.

The slide/swing door is assembled and mounted so that only the door plate 6 when the lock plate 8, a part of the closing element 9 and the door box 4 are visible, while all other parts are hidden in a wall shown in dashed line. The gaps between the door plate 6, the closing element 9, the door box 4 and the forward are minimal.

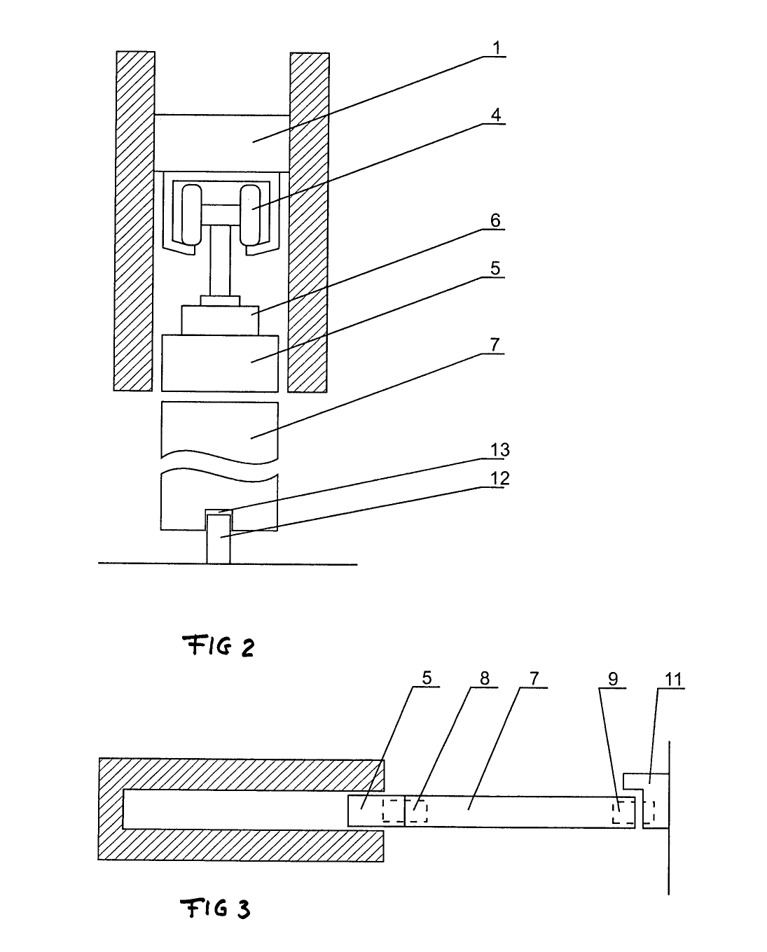

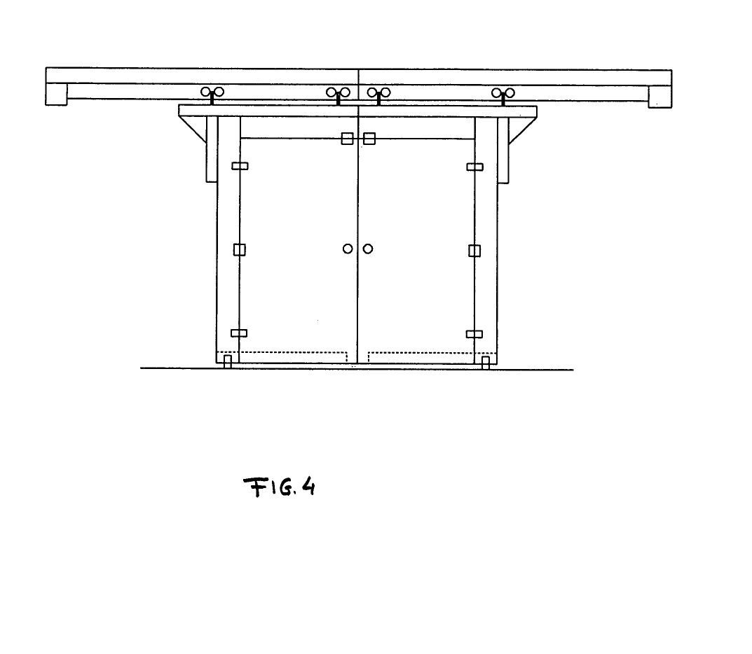

The side view and the top view in FIGS. 2 and 3 additionally clarify the structure of the door.

The slide/swing door is used in the following manner.

In an initial position the slide/swing door is moved out from the wall and closed. In this case is it possible to use the slide/swing door as a conventional swing door. For this purpose the lock 9 is opened, and, with overcoming the resistance of the fixator 10, the door is swung open. The slide/swing door can be also used as a sliding door. The horizontally-moving part manually can be completely moved into the wall, in which it is necessary to close the swing door, otherwise the wall and/or door can be damaged. For this purpose the lock 9 is open and the part is introduced into the wall. The part is suspended on the rollers 4 which slide over the upper guide 2. The flap 12 which engages in the slot 13 prevents shifting of the part. Also, the part can be introduced can be moved into the wall automatically by pressing the button. For this purpose the lock 9 is open and the button for turning on of the electric motor 3 is pressed. The electric motor 3 is connected by the drive with rollers 4, when the part is completely inserted into the wall the electric motor is turned off. In this case if the contact 14 is not closed, or in other words if the swing door is not closed completely, the button does not operate. The slide/swing door is moved from the wall also manually or automatically.

It will be understood that each of the elements described above, or two or more together, may also find a useful application in other types of constructions differing from the type described above.

While the invention has been illustrated and described as embodied in a slide/swing door, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A slide/swing door, comprising at least one horizontally-movable part; a mechanism for moving said part including guiding rails and elements of movement arranged on said guiding rails; a part suspended on the elements of movement, wherein the part is formed as a swing door including a door frame, a door panel, on hinges, and a fixator.

2. A slide/swing door as defined in claim 1, wherein said elements of movement are formed as roller carriages.

3. A slide/swing door as defined in claim 1, further comprising an electric motor, a drive and a device for controlling said electric motor with a blocking function.

4. A slide/swing door as defined in claim 1, further comprising a lower guide.

5. A slide/swing door as defined in claim 1, wherein said door frame includes two parts which are connected perpendicularly to one another.

6. A slide/swing door as defined in claim 1, further comprising an element for completing closure.

7. A slide/swing door as defined in claim 1, wherein said swing door includes an element for completing closure.

8. A slide/swing door as defined in claim 1, wherein said swing door has an element for closing.

9. A slide/swing door as defined in claim 1, wherein said hinges are formed as hidden hinges.

10. A slide/swing door as defined in claim 1, wherein said swing door has a lock.

11. A slide/swing door as defined in claim 1, comprising two said horizontal-moving parts.
